(19) United States
(12) Patent Application Publication
(10) Pub. No.: US 2013/0151315 A1
(43) Pub. Date: Jun. 13, 2013

(54) Representing Business Drivers and Outcomes to Facilitate Collaborative Planning

(71) Applicants: Tolulope Akinola, Palo Alto, CA (US); Riccardo Spina, Palo Alto, CA (US); Franz Aman, Palo Alto, CA (US); Frederic Samson, Palo Alto, CA (US)

(72) Inventors: Tolulope Akinola, Palo Alto, CA (US); Riccardo Spina, Palo Alto, CA (US); Franz Aman, Palo Alto, CA (US); Frederic Samson, Palo Alto, CA (US)

(73) Assignee: SAP AG, Walldorf (DE)

(21) Appl. No.: 13/315,808

(22) Filed: Dec. 9, 2011

(51) Int. Cl. G06Q 10/06

(52) U.S. Cl. 705/7.36

(57) ABSTRACT

A driver tree represents a model that models relationships between the various drivers of a business. The driver tree and the corporate outcomes computed from the driver tree may be presented in graphical display. The driver tree model may enable managers at any level of the organization to immediately see the impact of any changes they make on all parts of the corporate performance. Embodiments enable delegation of parts of the driver tree to persons with the nearest level of authority and oversight in corresponding parts of the business. The various branches of the driver tree may then be reassembled to create a more accurate view of ongoing strategies of the corporation as seen (and negotiated) by various layers of management.

### CROSS-REFERENCE TO RELATED APPLICATIONS

The present invention is related to commonly owned and concurrently filed U.S. application Ser. No. <TBD> entitled “Method and Apparatus for Business Drivers and Outcomes to Enable Scenario Planning and Simulation” (attorney docket no. 000005-018500US), which is incorporated herein by reference in its entirety for all purposes.

### BACKGROUND

The present invention relates generally to business planning and in particular to collaboration among people in a business.

Unless otherwise indicated herein, the approaches described in this section are not prior art to the claims in this application and are not admitted to be prior art by inclusion in this section.

With customers demanding increased flexibility from a business, and with fewer resources available, companies need to react more quickly to market demands. Knowing what operational levers within the organization can be altered to produce a positive effect on performance can be key to meeting these demands. Decision-makers must easily understand how varying options impact business operations in order to use resources as wisely as possible. A key question for any manager is to understand which of the multiple levers in their business can be moved to produce the most significant impact. In the absence of this knowledge, managers can waste time and resources on many seemingly “good” activities which, even when successfully executed, do little towards achieving business goals. Also, managers need to understand how their performance impacts the entire organization so they can choose wisely which goals to focus their resources on.

Another challenge that a business faces is resource management, especially since available resources are increasingly on the decline and/or expensive to acquire. Accordingly, resources within a business need to be distributed wisely. This is difficult to accomplish when executives and top-line managers are unable to determine the outcome of their ideas across the organization. Decision-makers need to quickly visualize how different scenarios would impact business operations before actually committing resources to implement them.

Without access to this kind of view, executives and their teams can waste enormous amounts of time on activities that end up doing very little to achieve the stated goals of the business. Real-time manipulation of operational levers within the business model can provide insight into which strategies would have a significant impact on overall performance, allowing resources to be utilized as effectively as possible.

Typical questions posed by decision-makers in a business may include inquiries like “How do I choose between these two business options?” or “How do I grow my business by 20%?” Executives generally turn to the following sources:

### Management Consultants

Organizations often hire management consultants for specialized expertise to help improve business performance. While their end-product may be valuable, hiring and briefing consultants can be time consuming and expensive. Consultants may spend several weeks understanding existing business problems and developing plans for improvement. It can be an expensive proposition, with minimum investment outlays sometimes totaling hundreds of thousands of dollars.

### Business Intelligence Software

Software solutions present data which allow users to analyze business performance. Business Intelligence (BI) tools are also valuable for accessing information to make sound business decisions, but it can be cumbersome and time consuming to use. The learning curve for this type of software can be fairly steep and often limited for use by business analysts. This usually means information may only be pulled on a quarterly basis, reducing the ability to move quickly with current data. These tools are usually unable to help users test theories.

### Spreadsheets

Spreadsheets are a mainstay in organizations today. Business modeling is often performed by a highly-trained business analyst whose turn-around time is slow and whose complex spreadsheets can be difficult to negotiate. These spreadsheets are also ill-suited to the collaborative nature of modeling exercises, which involve multiple parties making changes to targets and planning scenarios. They also tend to be used departmentally and thus the total impact to the enterprise and consequences for other parts of the business is unknown. Finally, trying to manage the sheer volume of spreadsheets within an organization, as well as the unintentional introduction of errors, can quickly become untenable.

Managers at different levels in organizations typically need to collaborate to achieve corporate goals. However, each manager may have a slightly different view of the business depending on where they are in the organization. They also may have different levels of granularity into the underlying business drivers for the overall business. For instance, the general manager (GM) may look at performance of overall product lines within a geographical region while a product line manager may be focused on the performance of a single product within another region. Despite these differences, the overall goals for both managers need to be coherent and the impact of decisions made by either of them needs to be transparent to the others.

The foregoing approaches, while valuable in their own right, each present a level of complexity, cost, and time expenditure that makes them impractical for regular use by executives. These and other issues are addressed by embodiments of the present invention, individually and collectively.

### SUMMARY

In embodiments, a method for collaboration among members in a business includes displaying a visual representation of a business model. The visual representation may be a driver tree. A segment of the business model may be identified in the visual representation and transmitted to a recipient. A received segment of the business model may be received and incorporated into the business model. In embodiments, the received segment of the business model may be a modification of the transmitted segment of the business model made by the recipient.

In embodiments, one or more outcomes of the business model may be displayed, including displaying updated outcomes when changes to the business model are made.

In embodiments, the transmitted segment of the business model may be sent to two or more recipients.

In embodiments, displaying differences between the transmitted segment of the business model and the received segment of the business model.

In embodiments, two or more segments of the business model may be merged to generate a new segment. The user may provide input to control the merging of the two or more segments.

The following detailed description and accompanying drawings provide a better understanding of the nature and advantages of the present invention.

### BRIEF DESCRIPTION OF THE DRAWINGS

FIG. 1 represents a system level diagram of a computer system in accordance with an embodiment.

FIG. 2 illustrates a graphical user interface (GUI) in accordance with embodiments of the present invention.

FIG. 3 shows a high level flow of collaboration among members of a business in accordance with principles of the present invention.

FIGS. 4A-4C illustrate GUIs for sending and receiving portions of a business model in accordance with disclosed embodiments.

FIGS. 4D-4E illustrate GUIs for viewing model segments in accordance with disclosed embodiments.

FIGS. 4E-4G illustrate comparing model segments in accordance with disclosed embodiments.

FIG. 4H illustrates merging model segments in accordance with disclosed embodiments.

FIGS. 4I-4J illustrate incorporating a new model segment into a business model.

### DETAILED DESCRIPTION

In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include modifications and equivalents of the features and concepts described herein.

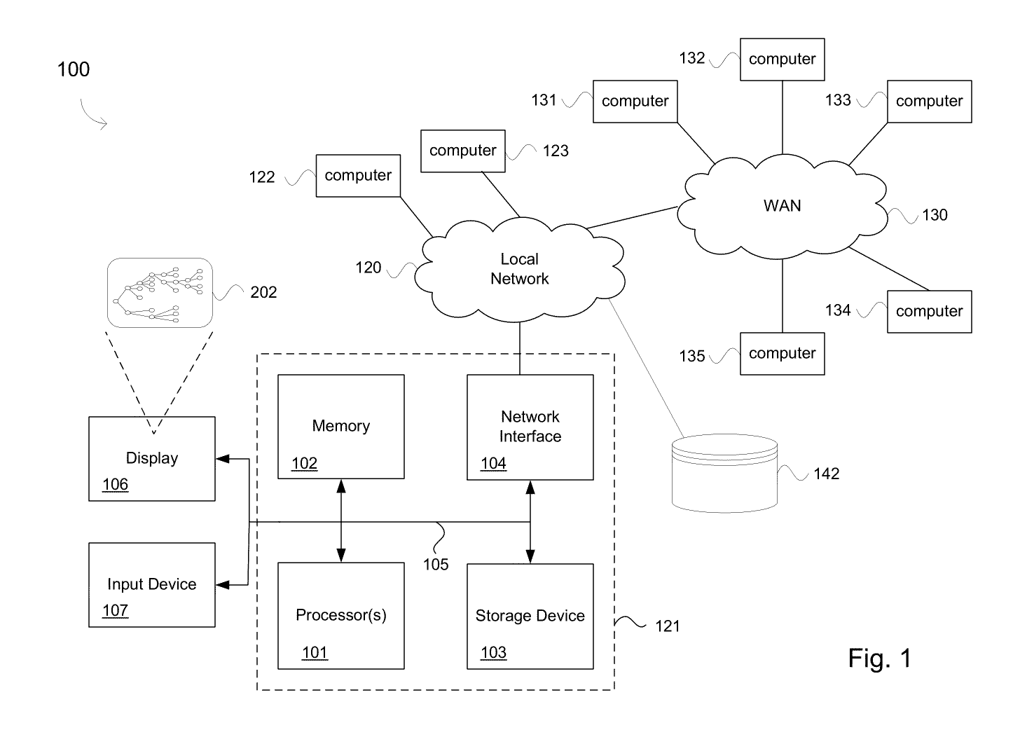

Referring to FIG. 1, a computing system 100 in accordance with embodiments of the present invention may include a plurality of computers 121-123 connected to a local communication network 120 within a business unit of the business (e.g., corporate headquarters, production facility, regional sales office, and so on). The local communication network 120 may connect to a company-wide wide area network 130, which may include connection to the Internet.

Computers 131-135 in the other business units of the business may connect to the either the local communication network 120 or to the WAN 130. Computers 121-123 and 131-135 may be configured as any suitable computing devices that may be used in the business. For example computers 121-123 and 131-135 may include tablet computers (e.g., Apple iPad® computer), laptop computers, desktop computers, and so on. The computers 121-123 and 131-135 may include server systems used by the business; for example, PLM (product lifecycle management), CRM (customer relationship management), PPS (product production system), and so on. The computers may include storage servers; for example, storage server 142.

A typical computer 121 may include a data processor subsystem 101 comprising one or more data processing units. The computer 121 may include a memory subsystem 102 which may comprise any combination of random access memory (usually volatile memory such as DRAM) and non-volatile memory such as FLASH memory, ROM, and so on. The computer 121 may include a storage subsystem 103 comprising one or more storage devices such as hard disk drives and the like. The storage subsystem 103 may include remote storage systems; e.g., for data minoring, remote backup and such. A network interface subsystem 104 can provide access to the network 120. A system of buses 105 may interconnect the foregoing subsystems, providing control lines, data lines, and/or voltage supply lines to/from the various subsystems.

The computer 121 may include a suitable display(s) 106 and input devices 107 such as a keyboard, a mouse input device, a voice input device, and so on. In embodiments, typical devices may include tablet computers such as the Apple iPad® tablet computer which employs a touch sensitive screen that serves both as a display and as an input device. Other devices include laptop computers that use a built-in input device such as a touch pad or an external input device such as a mouse, and desktop computers.

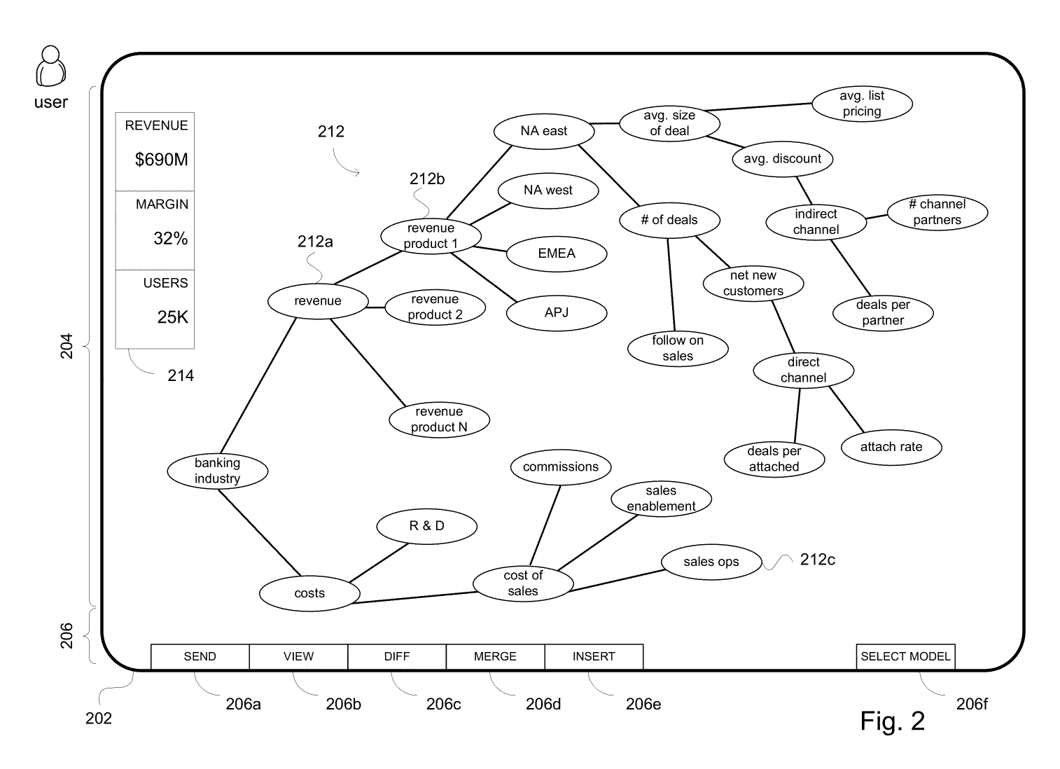

Computer executable program code may be stored on the memory subsystem and/or storage subsystem 103. When the computer executable program code is executed by the data processor subsystem 101, the computer 121 may operate as a collaborative system in accordance with the present invention. A driver tree model of the business may be stored in the computing system 100. For example, the driver tree may be stored on the storage subsystem 103 of the computer 121, or on a storage server 142, and so on. The computer 121 may display a graphical user interface (GUI; e.g., 202 FIG. 2) on the display 106 to provide a user with access to a graphical representation of the driver tree. The GUI 202 may receive input from the user to access the driver tree. The “user” may be a human user, or an automated process running on another computer.

In embodiments, collaboration using a graphical representation of a business model of a business organization may be performed on a computer in a company-wide computer system. In embodiments, the business model may be expressed using a “driver tree,” and collaboration efforts may be conducted by operating on graphical depictions of the driver tree. A driver tree associates business levers to outcomes. “Business levers” are aspects of a business that a decision maker (e.g., executive, manager, etc.) can change in order to improve some aspect of the business. “Outcomes” are the effects on various aspects of the business as a result of adjusting the business levers. For example, the production levels of a widget may be a business lever that a manager can adjust, namely increase the production of widgets or decrease the production of widgets. An outcome of adjusting the production levels of widgets may be the total revenue collected in a sales area where widgets, and other products of the business, are sold.

In embodiments, a graphical user interface such as the GUI 202 illustrated in FIG. 2 may be employed to display a graphical representation of the business model for a business. For example, a driver tree 212 may be used to visualize the business model in a graphical representation. The GUI 202 may include a display area 204 for displaying the driver tree 212, and a commands area 206 for displaying buttons 206a-206f that can provide access to functions that facilitate the collaborative process. The driver tree 212 includes an outcomes view 214 to display business performance metrics computed from the driver tree.

The driver tree 212 may comprise nodes that represent various elements of the business and links between the nodes to represent relationships among such elements. For example, node 212a may represent the total revenue generated by the business. Node 212b may represent the total revenue generated from sales of “product 1.” A node 212c may relate to the overhead for sales operations, and so on.

The outcomes view 214 represents various measures of business performance (e.g., total revenue, size of customer base, and so on) that are of interest to decision makers, which are determined from the driver tree 212. For example, a REVENUE measure may be computed directly from node 212a by summing the revenue collected from the sales of products 1 to N. A MARGINS measure may be computed from the driver tree 212, and so on. Modifications made to the driver tree 212 may propagate through various nodes in the driver tree, and may manifest as changes to the computed measures of business performance metrics displayed in the outcomes view 214.

Additional details about the driver tree 212, the outcomes view 214, and the GUI 202 in general are disclosed in commonly owned and concurrently filed U.S. application Ser. No. ______, filed ______, entitled “Method and Apparatus for Business Drivers and Outcomes to Enable Scenario Planning and Simulation” (attorney docket no. 000005-018500US), which is incorporated herein by reference in its entirety for all purposes.

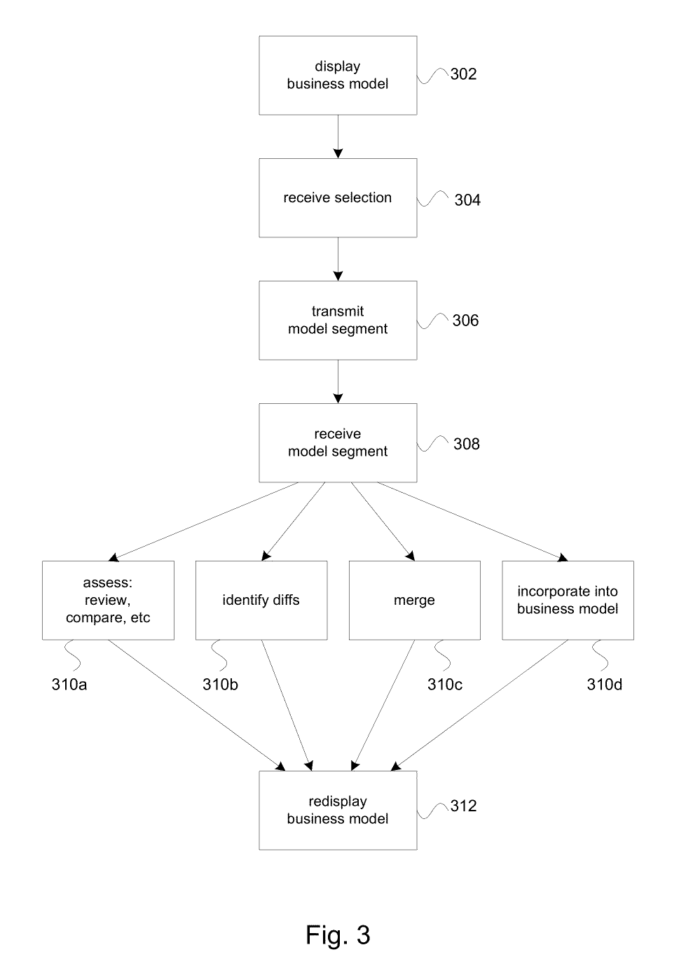

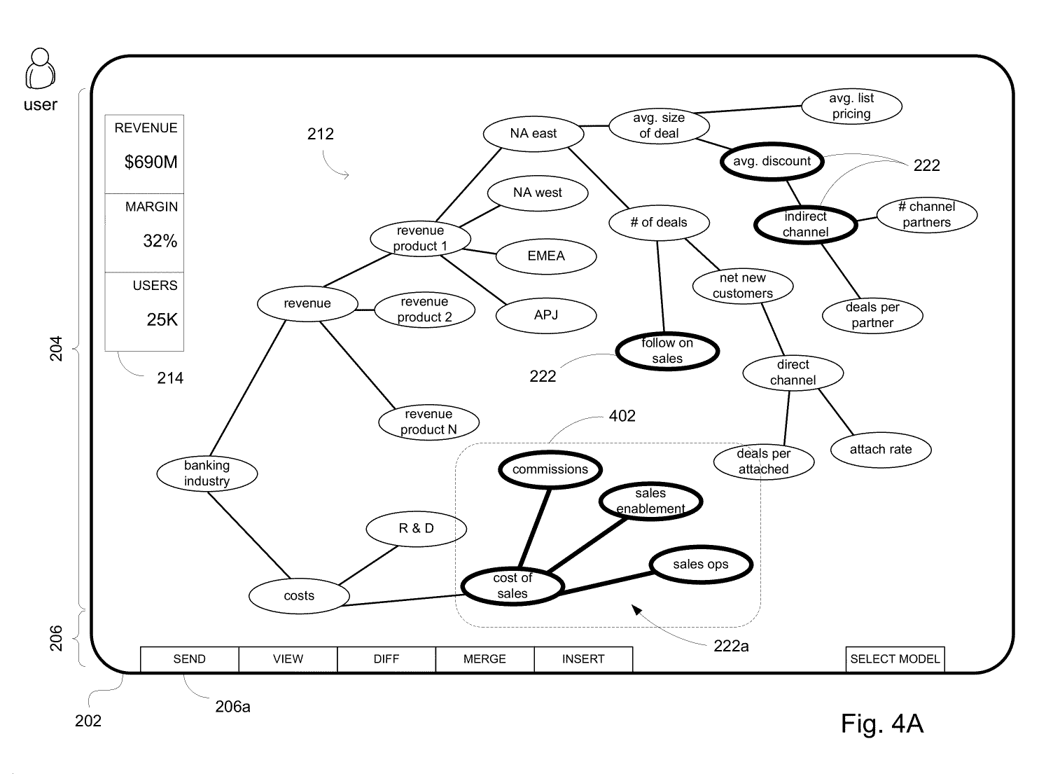

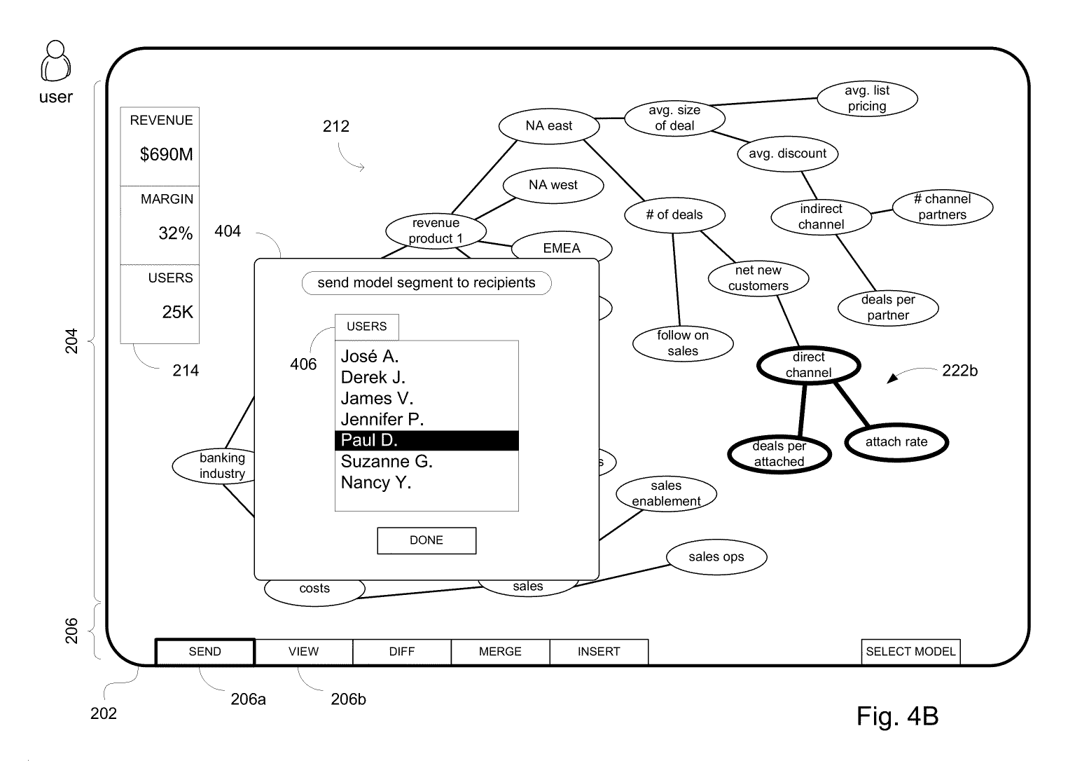

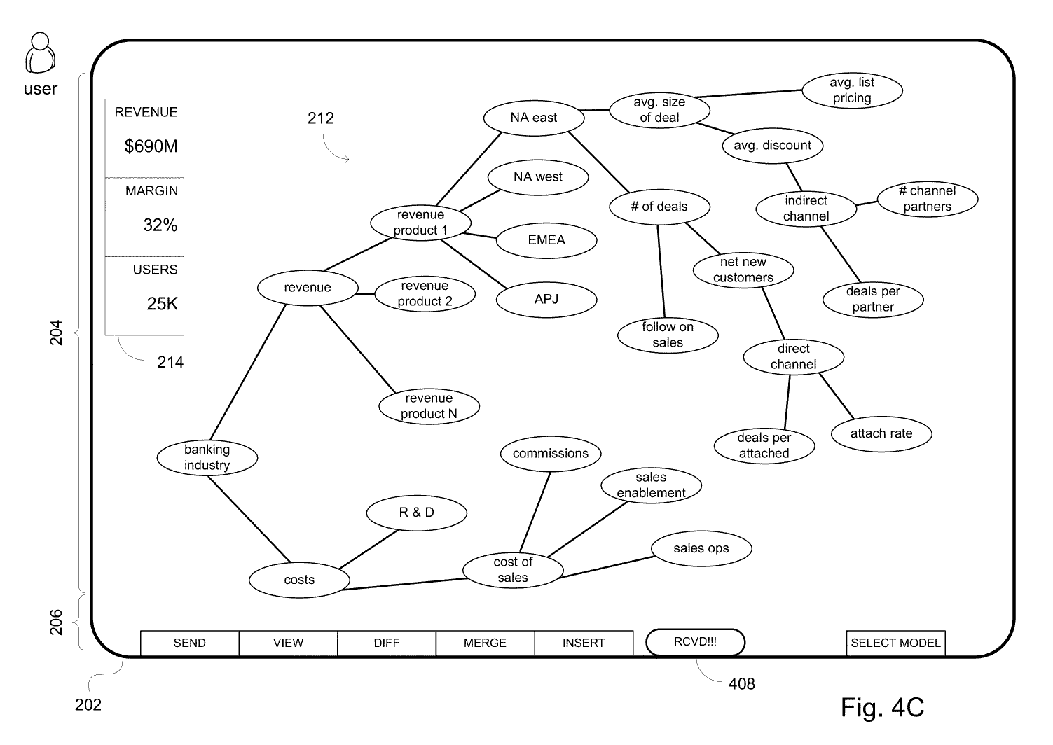

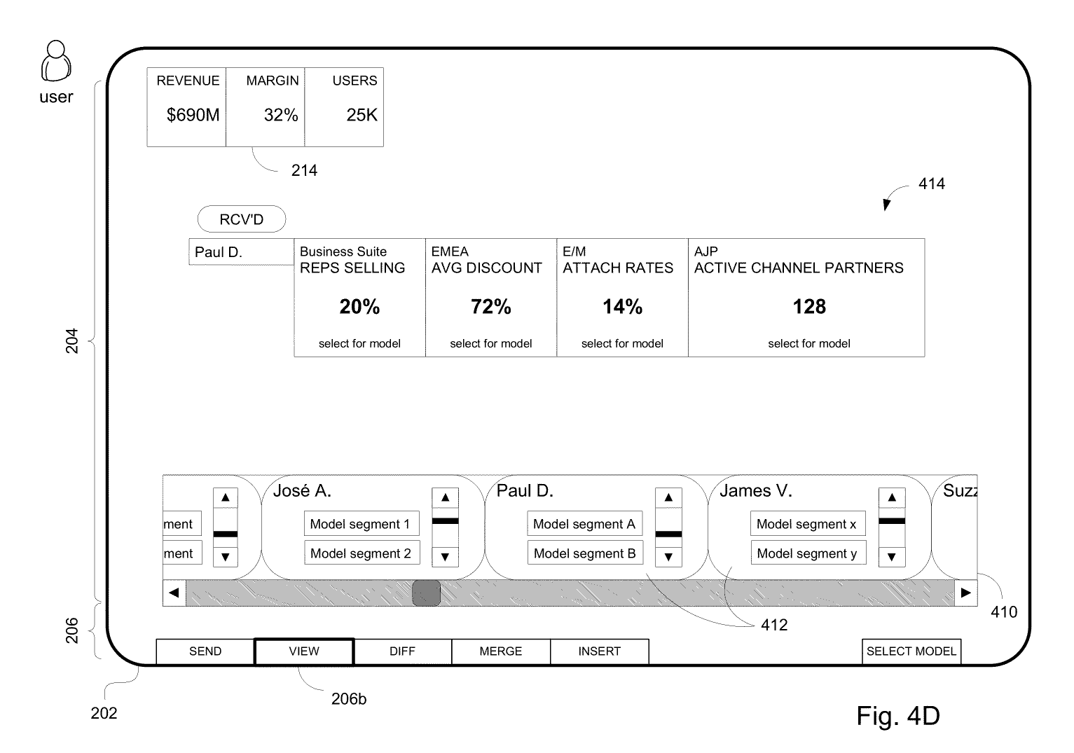

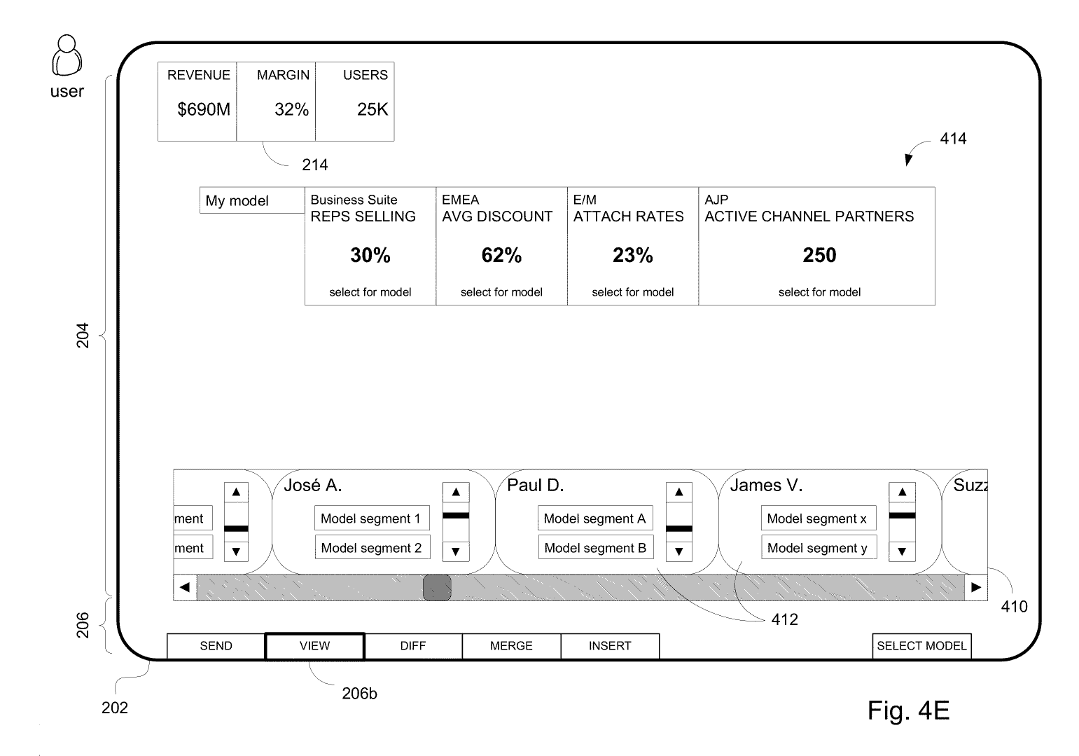

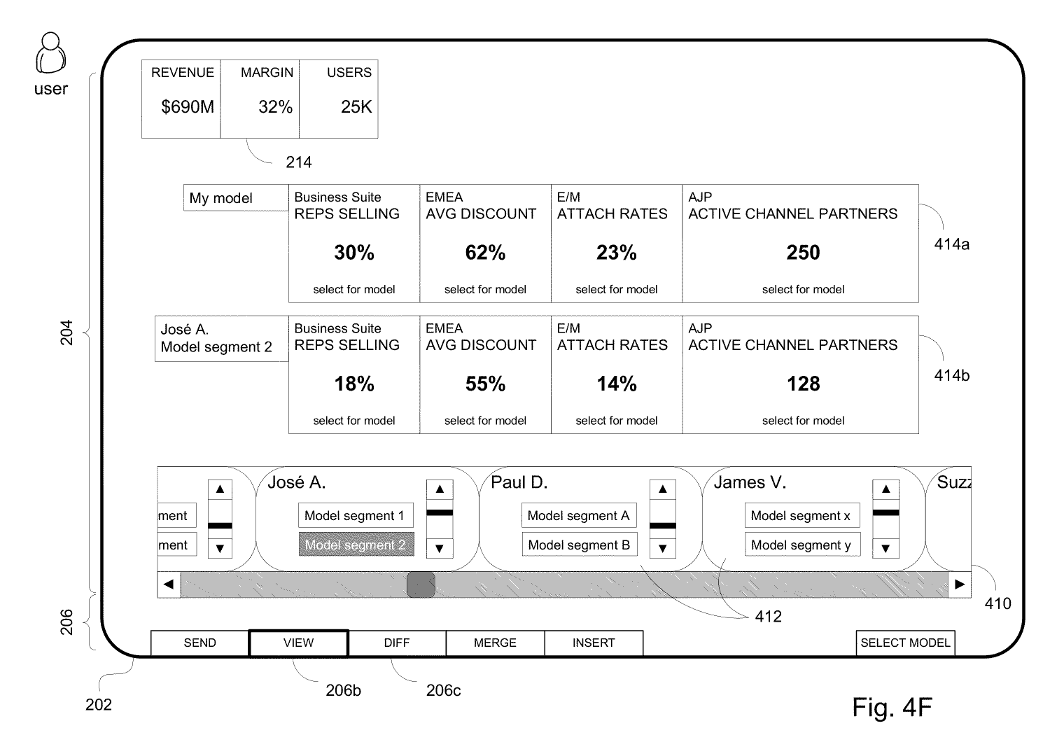

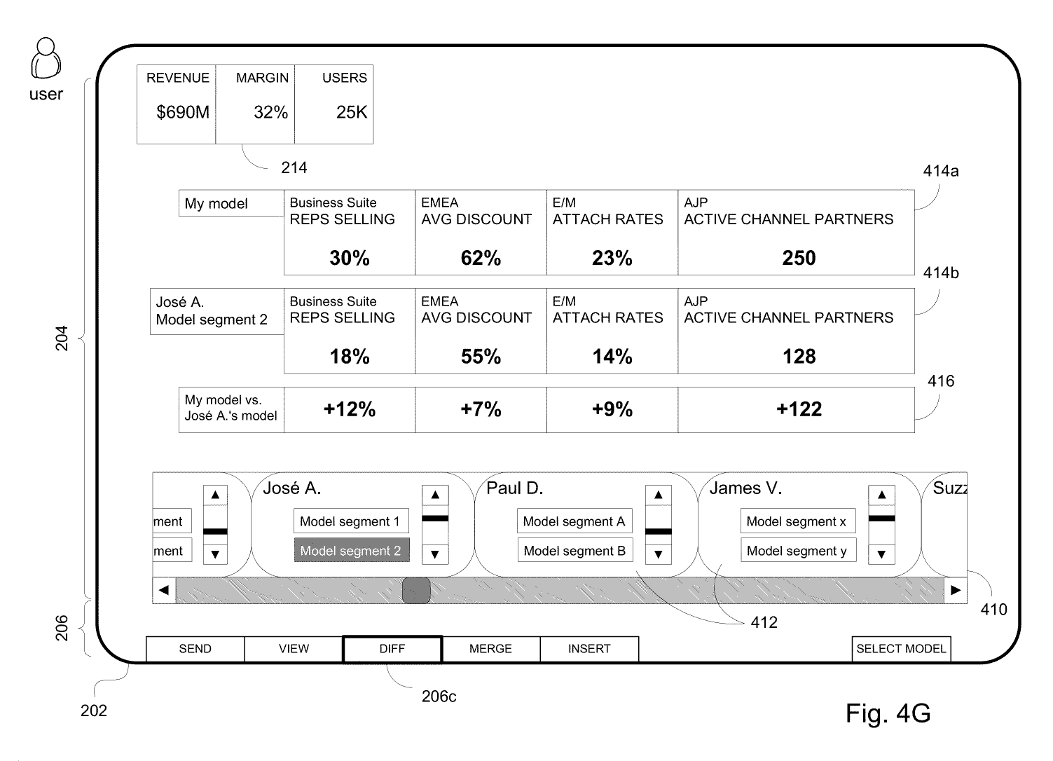

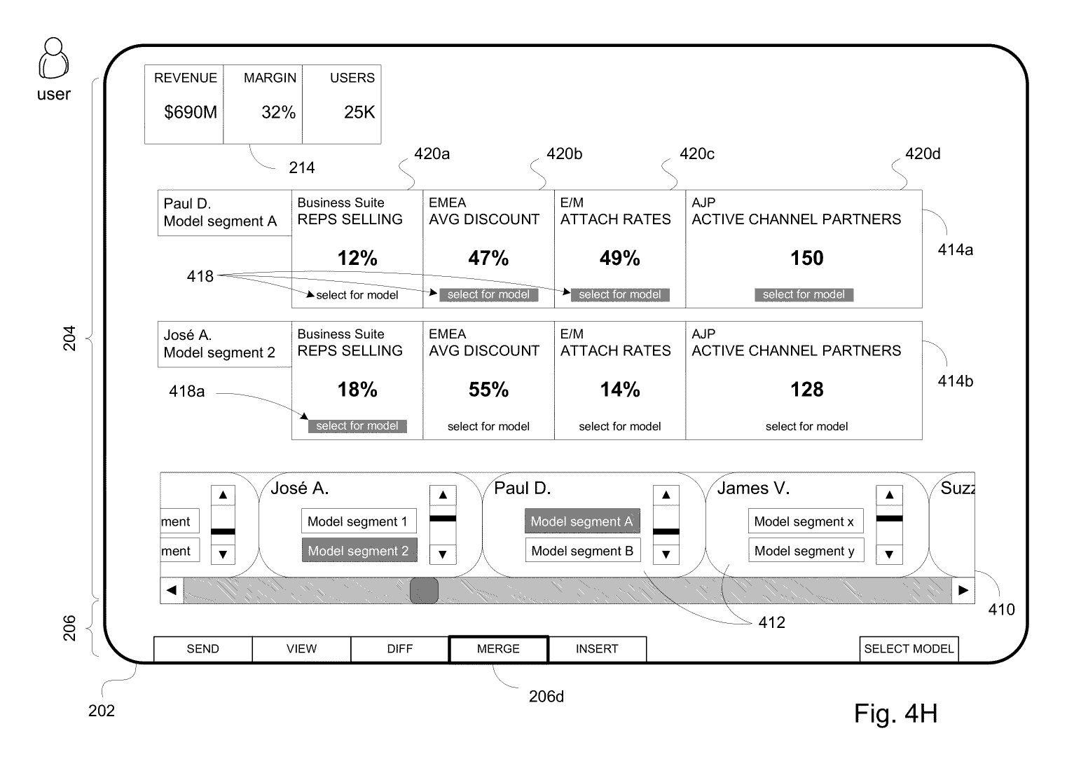

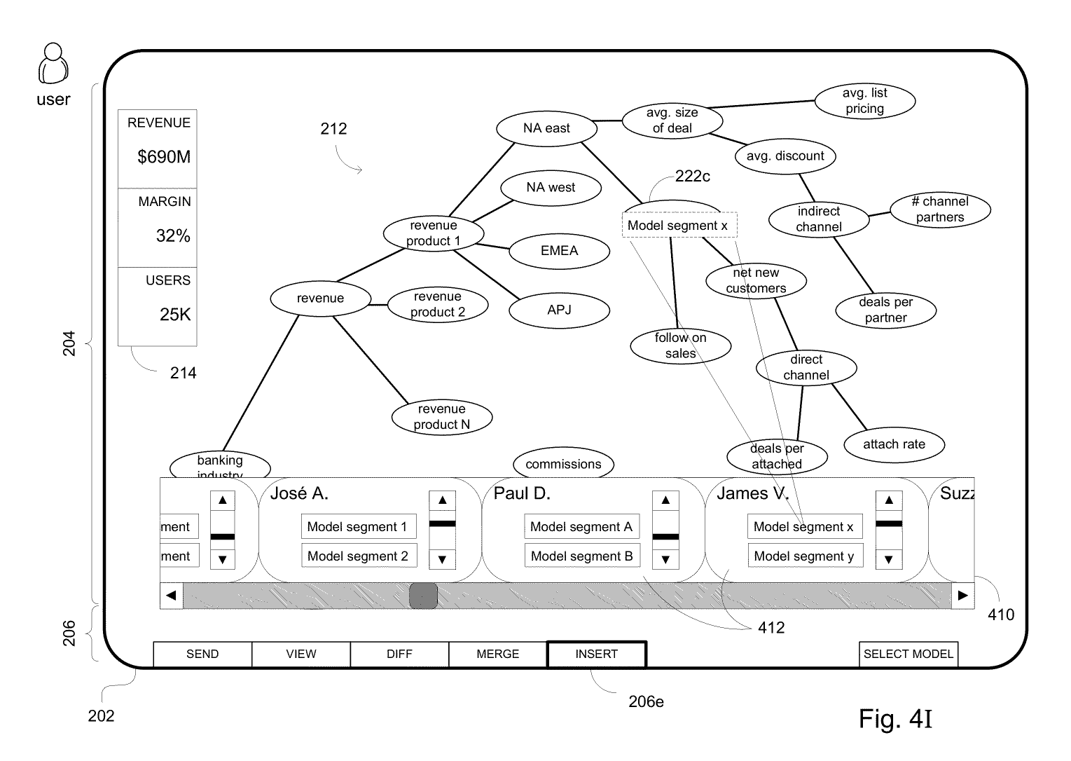

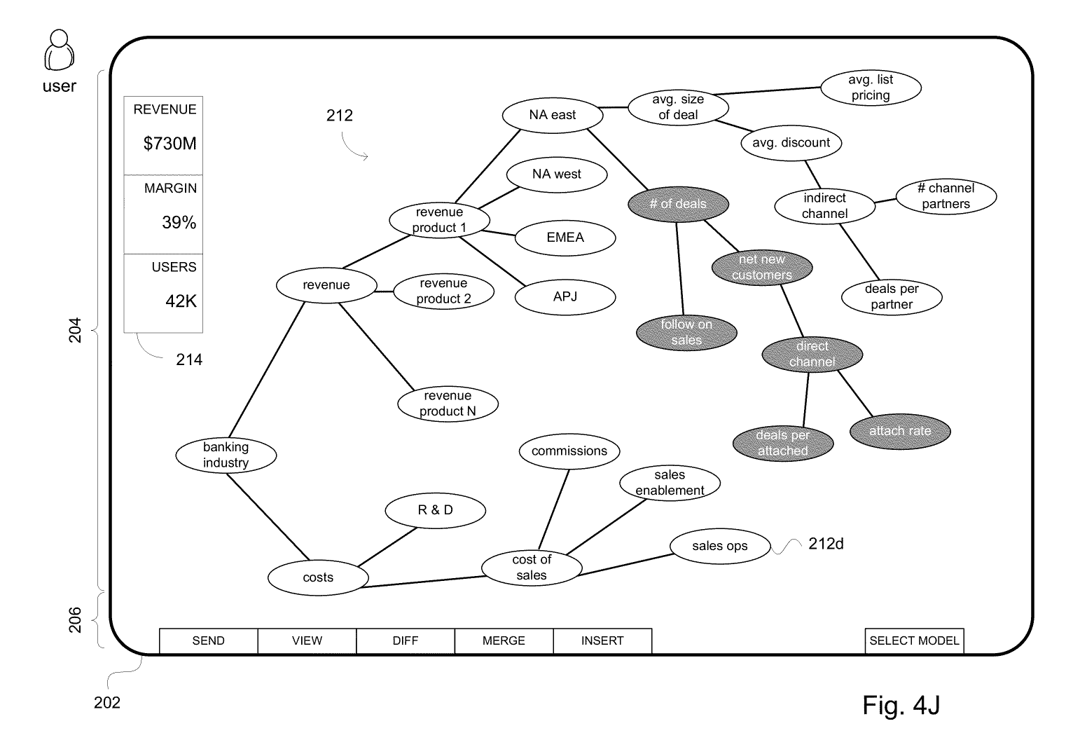

Referring to FIGS. 3 and 4A-4H, the collaborative process in accordance with embodiments may include displaying (block 302) a graphical representation of a selected business model of the business organization on a suitable display. For example, a SELECT MODEL button 206f may be used to display a list of business models from which to choose a selected business model. The display, for example, may be the screen of a touch pad computing device, a laptop computer, the monitor of a desktop configuration, and so on. In embodiments, a driver tee 212 such as shown in FIG. 4a may be used to visually represent the business model. A user may access the driver tree 212 via GUI 202 using a suitable input interface; for example, input devices such as a touchpad a mouse, a graphics tablet, a voice input, and so on.

FIG. 3, BLOCK 304

In embodiments, the user may select a segment of the selected business model in order to assess it. For example, an executive in the business may want to assess some aspect of the business or consider how to improve performance in the business. In a block 304, the user may identify a segment (or portion) of the selected business model by selecting one or more nodes of the driver tree 212. As used herein, the phrase “model segment” may be used to refer to a segment of the business model, which may include the entire business model or a portion of the business model. Selected nodes may be viewed as representing a segment of the business model and hence some aspect of the business. For example, the group of nodes 222a shown in FIG. 4A may represent a segment of the business model that relates to the cost of the sales group. The user may select the group of nodes 222a, for example, by drawing a selection box 402 around the group of nodes of interest. FIG. 4A further illustrates that the user instead may select individual nodes 222 from the driver tree 212; for example, by “clicking” on each node using a mouse input device. Selected nodes may be indicated, for example, using bold lines as shown in the figure.

FIG. 3, BLOCK 306

In embodiments, the user may transmit a segment of the selected business model to a recipient. For example, the executive may want to share a portion of the business model that represents a business unit with the manager of that business unit in a collaborative effort to identify potential improvements. Accordingly, in a block 306, nodes that are identified and selected by the user, which correspond to a segment of the business model, may be sent to one or more recipients. In embodiments, a suitable internal representation of the segment(s) of the business model corresponding to the selected node or nodes may be sent to one or more recipients; for example, using email. FIG. 4B is illustrative. Suppose the user made a selection of the group of nodes 222b shown in the figure. The user may “click” on the SEND button 206a displayed in the command section 206 of the GUI 202 to transmit the model segment that corresponds to the selected group of nodes 222b. The figure illustrates an example of the GUI 202 prompting the user to identify one or more recipients. In an embodiment, for example, a SEND command window 404 may pop up with a drop-down menu 406 displayed in the command window. When the user selects a user/recipient from the drop-down menu 406, a copy of the model segment may be transmitted to the selected recipient. The user may send the model segment to additional recipients by repeatedly selecting users from the drop-down menu 406. A DONE button may be provided to allow the user to close and exit the SEND command window 404.

FIG. 3, BLOCK 308

In a block 308, the user may subsequently receive a model segment from a sender. The received model segment may be a modified or otherwise updated version of a previously transmitted model segment. Consider the following example. Suppose in block 306 the user had transmitted model segment corresponding to the group of nodes 222b to “Paul D.” If Paul D. modifies some aspect of the model segment, she may at some point in time send the modified model segment back to the user. When a model segment is received, the GUI 202 may display a suitable alert 408 (FIG. 4C) to call the user's attention to that fact.

The received model segment may be a segment that is new to the selected business model. For example, a manager of a production line may have a proposal to expand the production line to increase production capacity. That manager may develop a model of the proposed new production line and transit the model a as a model segment to an executive, who may then assess it consider incorporating it into the business model.

FIG. 3, BLOCK 310a

In embodiments, the user may assess model segments including reviewing details of the model segment, comparing two or more model segments, and so on. The user may assess a received model segment. The user may assess already stored model segments (e.g., storage server 142 may store a collection of model segments), selected segments of the selected business model, and so on. Accordingly, in a block 310a, the user may review the details of a received model segment. For example, in FIG. 4C, if the user is alerted to the receipt of a model segment, they may click on the VIEW button 206b in order to view details of the received model segment. The GUI 202 may change to display an interface for viewing model segments, and in this case to view the received model segment as shown in FIG. 4D. The user may want to review part of their business model. Accordingly, the user may identify a portion of the selected business model by selecting one or more nodes in the driver tree 212, and review the selected model segment. For example, in FIG. 4B, the user may click on the VIEW button 206b to view details of the selected nodes 222b. The GUI 202 may change to display the interface for viewing model segments, and in this case to view the model segment corresponding to the selected nodes 222b as shown in FIG. 4E.

Referring to FIGS. 4D and 4E, in embodiments, the GUI 202 may include a display for viewing model segments. In an embodiment, a user selection window 410 may be presented in the display area 204 to display a list of users (e.g., executives, managers, etc.) in the business who may be responsible for one or more segments of the selected business model. For example, a user may have received a model segment from another user, or may have created their own model segment, or may have been assigned responsibility of a model segment, and so on. In an embodiment, the user selection window 410 may display a model selector 412 that is associated with each user. Model segments associated with a given user (e.g., Jose A.) and stored in a suitable storage system can be accessed via the model selector 412. For example, as shown in FIGS. 4D and 4E, the model selector 412 may include a scrollable window that can be scrolled up and down to display the model segments associated with a given user.

In embodiments, entire business models associated with a user may be selected by the model selector 412, in addition to selecting model segments of a business model. For example, Jose may have developed his own version of the business model. The user may compare the entire selected business model against Jose's version of the business model.

Continuing with block 310a, the user may compare two or more model segments, including already stored model segments, selected segments of the selected business model, received model segments, and so on. For example, the user may compare the received model segment against already stored model segments. The user may compare the received model segment against other parts of the business model. The use may select and compare segments from among already stored model segments, and so on. FIG. 4F shows the GUI 202 displaying a side-by-side view of details of two model segments: a portion of the selected business model 414a and Jose's model segment 414b.

FIG. 3, BLOCK 310b

In addition to performing a side-by-side review of two or more model segments, the user may generate a quantitative assessment of differences between model segments. Accordingly, in a block 310b, the user may compare two or more model segments to identify differences between the model segments. For example, a received model segment may be a proposal on how to improve the business. The user may perform a difference operation on the received model segment and the corresponding portion of the selected business model to identify quantitative differences between the two models in order to further assess the proposal. The user may compare already stored model segments with each other; for example alternative models for a segment of the business model may be compared and evaluated. FIGS. 4F and 4G are illustrative. FIG. 4F shows a side-by-side comparison of the details 414a and 414b of two model segments. The user may click on the DIFF button 206c to initiate a quantitative comparison between the two model segments. The GUI 202 shown in FIG. 4G shows a results window 416 for displaying results of the quantitative comparison.

In embodiments, side-by-side comparisons of entire business models may be made, in addition to comparing model segments. Aspects of the GUI 202 discussed above in connection with FIGS. 4F and 4G apply to side-by-side comparisons of entire business models. For example, Jose's version of the business model may be compared to the selected business model in a manner similar to side-by-side comparisons of model segments.

FIG. 3, BLOCK 310c

In addition to performing a side-by-side review of two or more model segments as discuss in blocks 310a and 310b, the user may merge (block 310c) two or more model segments in order to generate a new model segment. For example, the user may want to generate a model segment that captures the best features in each of the original model segments. FIG. 4H is illustrative. The GUI 202 shows a display for viewing model segments. The figure shows that model segments from Jose and Paul have been selected. The figure shows details 414a and 414b of the selected model segments. Selection indicators 418 may be displayed among the details 414a of a model segment. The user may then click on different elements 420a-420d of each of the model segment details 414a and 414b to identify those parts that will constitute the new model segment. The user may simply click on each element of interest. The selection indicator (418a) of a selected element may be highlighted to indicate the selection. The user may then click on the MERGE button 206d to combine the selected elements from each model segment to define the new model segment.

In embodiments, elements from two business models may be combined to generate a new business model of a business. In a manner similar to merging elements from two model segments to generate a new model segment, elements from two entire business models may be selected and merged to generate a new business model for the business.

FIG. 3, BLOCK 310d

In embodiments, the user may incorporate new model segments into the selected business model (block 310d). The user may access an existing model segment and incorporated it into the business model. The user may incorporate a received model segment into the business model. For example, referring back to block 306, the recipient of a previously transmitted model segment may make some modifications to it and the modified model segment back to the user. The user may then incorporated the modified model segment into the business model. This represents an example of collaborative interaction in accordance with the present invention, that may facilitate improving and/or developing the business. Allowing other members to view and propose changes to the business model allows for the incorporation into the business model of insight and information from members in the business who may have knowledge that the user may not possess.

FIG. 4I shows an example of the GUI 202 for inserting a model segment. An INSERT button 206e may be provided. When the user clicks on the INSERT button 206e, the GUI 202 may display the driver tree 212 and overlay the driver tree with a display of the user selection window 410. The user may navigate the user selection window 410 and a model selector 412 to identify a desired model segment. The figure shows, for example, the selection of “Model segment x” belonging to James V. The user may “drag-and-drop” the selected model segment onto a node 222c in the driver tree 212. The portion of the business model represented by the node 222c may then be replaced by the model segment “Model segment x.”

FIG. 3, BLOCK 312

Any changes made to the selected business model may be displayed on the GUI 202. Accordingly, in a block 312 the display of the driver tree 212 may be updated to reflect changes in the driver tree; e.g., the addition and/or deletion of nodes, moving a group of nodes to another part of the driver tree, and so on. In embodiments, changes made to the driver tree 212 may initiate a re-computing of the business model. Accordingly, the business performance metrics displayed in the outcomes view 214 may be updated as a result of the computation. Depending on changes made to the driver tree 212, metrics may be removed from the outcomes view 214 and new metrics may be included.

FIG. 4J shows an example of the GUI 202 having redisplayed the driver tree 212 and the outcomes view 214 in response to the model segment “Model segment x” being incorporated into the selected business model to update the business model. The incorporated model segment may be visually identified in the driver tree 212, for example using different shading or coloring of the nodes that represent the incorporate model segment. The outcomes view 214 may be updated with new values for the business performance metrics computed from the updated business model.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

1. A method for collaboration in a business comprising:
displaying by a computer a graphical representation of a business model, the business model comprising a representation of business elements that comprise the business and relationships among the business elements;
receiving by the computer input indicative of a selected portion of the graphical representation;
sending by the computer to at least one recipient a first business model segment which represents a portion of the business model that corresponds to the selected portion of the graphical representation;
receiving by the computer a second business model segment;
incorporating by the computer the second business model segment into the business model to generate an updated business model; and
displaying by the computer a graphical representation of the updated business model.

2. The method of claim 1 further comprising displaying one or more outcomes of the business model, wherein the one or more outcomes are updated when the updated business model is displayed.

3. The method of claim 1 wherein the second business model segment is a modification of the first business model segment.

4. The method of claim 1 further comprising receiving a revised business model segment which represents a modification of the first business model segment.

5. The method of claim 1 wherein the graphical representation comprises a representation of a tree diagram comprising nodes and interconnections among the nodes, wherein the nodes correspond to the business elements of the business and the interconnections correspond to the relationships among the business elements.

6. The method of claim 1 wherein the step of sending to at least one recipient includes:
sending the first business model segment to a first recipient; and
sending the first business model segment to a second recipient.

7. The method of claim 1 further comprising displaying two or more business model segments.

8. The method of claim 1 wherein the second business model segment is a modification of the first business model segment, the method further comprising displaying differences between the first business model segment and the second business model segment.

9. The method of claim 1 further comprising:
merging two or more business model segments to generate a merged business model segment; and
incorporating the merged business model segment into the business model.

10. The method of claim 9 further comprising receiving user input to control the merging.

11. A collaborative system comprising:
a computer; and
a computer executable program configured to cause the computer to:
display a graphical representation of a business model, the business model comprising a representation of business elements that comprise the business and relationships among the business elements;
receive input indicative of a selected portion of the graphical representation;
send to at least one recipient a first business model segment which represents a portion of the business model that corresponds to the selected portion of the graphical representation;
receive a second business model segment;
incorporate the second business model segment into the business model to generate an updated business model; and
display a graphical representation of the updated business model.

12. The system of claim 11 wherein the computer executable program is further configured to cause the computer to display one or more outcomes of the business model, wherein the one or more outcomes are updated when the updated business model is displayed.

13. The system of claim 11 wherein the second business model segment is a modification of the first business model segment.

14. The system of claim 11 wherein the computer executable program is further configured to cause the computer to send the first business model segment to a first recipient and to a second recipient.

15. The system of claim 11 wherein the second business model segment is a modification of the first business model segment, wherein the computer executable program is further configured to display differences between the first business model segment and the received second business model segment.

16. A non-transitory computer readable medium having stored thereon computer executable program, which when executed by a computer will cause the computer to:
display a graphical representation of a business model, the business model comprising a representation of business elements that comprise the business and relationships among the business elements;
receive input indicative of a selected portion of the graphical representation;
send to at least one recipient a first business model segment which represents a portion of the business model that corresponds to the selected portion of the graphical representation;
receive a second business model segment;
incorporate the second business model segment into the business model to generate an updated business model; and
display a graphical representation of the updated business model.

17. The computer readable medium of claim 16 wherein the computer executable program is further configured to cause the computer to display one or more outcomes of the business model, wherein the one or more outcomes are updated when the updated business model is displayed.

18. The computer readable medium of claim 16 wherein the second business model segment is a modification of the first business model segment, wherein the computer executable program is further configured to display differences between the first business model segment and the second business model segment.

19. The computer readable medium of claim 16 wherein the computer executable program is further configured to cause the computer to:
merge two or more business model segments to generate a merged business model segment; and
incorporate the merged business model segment into the business model.

20. The computer readable medium of claim 19 wherein the computer executable program is further configured to cause the computer to receive user input to control merging of the two or more business model segments.

21. The method of claim 1 wherein the first business model is different from the second business model.
